(19) United States
(12) Patent Application Publication
(10) Pub. No.: US 2008/0212015 A1
(43) Pub. Date: Sep. 4, 2008

(54) Method for manufacturing liquid crystal display panel

(75) Inventors: Chia-Ming Chan, Miao-Li (TW); Yar-Ping Lin, Miao-Li (TW); Hung-Sheng Cho, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/005,703

(22) Filed: Dec. 27, 2007

(30) Foreign Application Priority Data
Dec. 29, 2006 (TW) 95149711

(51) Int. Cl. G02F 1/13

(52) U.S. Cl. 349/190

(57) ABSTRACT

An exemplary method for manufacturing a liquid crystal display (LCD) panel (20) includes: providing a first and a second substrates (21, 22), each substrate including a display region (212, 222), a periphery region (214, 224) surrounding the display region, and a sealant adhesive region (215, 225) located between the display region and the periphery region; forming data lines (223) and gate lines (221), and the data lines and gate lines extending to the periphery region; forming an alignment film (240) on the second substrate, the alignment film covering the display region and the periphery region; rubbing the alignment film; forming a sealant; injecting liquid crystals; attaching the two substrates to form an LCD panel; etching the alignment film to expose end portions of the data lines and gate lines.

### FIELD OF THE INVENTION

The present invention relates to methods for manufacturing liquid crystal display panels, and particularly to a method for manufacturing a liquid crystal display panel in an alignment process which can avoid damages of conductive lines.

### GENERAL BACKGROUND

The liquid crystal display has been applied to various electronic equipments in which messages or pictures need to be displayed, such as mobile phones and notebook computers. An LCD panel is a main part of a typical LCD. When an LCD panel is manufactured, an alignment process is an essential requirement.

Referring to FIG. 13, a typical mother LCD panel 100 includes a first mother substrate 110, a second mother substrate 120 and a liquid crystal layer 130 interposed therebetween. The first mother LCD substrate 110 includes a plurality of color filter substrates 111. The second LCD substrate 120 includes a plurality of thin film transistor (TFT) array substrates 121. A second alignment film 140 is formed on each of the TFT array substrates 121 of the second LCD substrate 120. A color filter substrate 111, a corresponding TFT array substrate 121, and the liquid crystal layer 130 interposed therebetween define an LCD panel (not labeled). The LCD panel is manufactured as follows.

In step S11, a first mother substrate 110 and a second mother substrate 120 are provided. The first mother substrate 110 includes a plurality of color filter substrates 111. The second mother substrate 120 includes a plurality of TFT array substrates 121.

In step S12, a plurality of color filters (not shown) are formed on the first mother substrate 110, and each color filter corresponds to one of the color filter substrates 111. A plurality of TFT array layers are formed on the second mother substrate 120, and each TFT array layer is correspondingly located at one of the TFT array substrates 121.

Referring to FIG. 14, this is a top plan view of one of the TFT array substrates 121. An entire surface of the TFT array substrates 121 includes a display region 122, a periphery region 124, a sealant adhesive region 125, and a chip attachment region 126. The display region 122 locates in the center of the TFT array substrate 121. The periphery region 124 surrounds the display region 122. The sealant adhesive region 125 locates between the display region 122 and the periphery region 124. The chip attachment region 126 locates between the periphery region 124 and the sealant adhesive region 125, and has an L-shaped profile. That is, the chip attachment region 126 only locates two adjacent sides of the TFT array substrate 121. A plurality of TFTs (not shown) are formed on the display region 122. A plurality of conductive lines (not shown) are formed on the sealant adhesive region 125, the chip attachment region 126, and the periphery region 124. The conductive lines include data lines and gate lines. The TFTs are connected to external circuits (not shown) such as driving chips via the conductive lines.

In step S113, a first alignment film (not shown) is formed on each of the color filter substrates 111 of the first mother substrate 110, and a second alignment film 140 is formed on each of the TFT array substrates 121 of the second mother substrate 120. On each TFT array substrate 121, the second alignment film 140 is formed only on the display region 122, and the periphery region 124, and does not cover the sealant adhesive region 125, and the chip attachment region 126. Thus, extensive conductive lines are exposed.

Referring to FIG. 15, in step S14, a rubbing process of the second alignment film 140 is conducted by an alignment apparatus (not labeled). The alignment apparatus includes a roller 10 and a workbench 12 for supporting the TFT array substrates 121. A velvet cloth 11 is wrapped on the roller 10. The workbench 12 is moved horizontally toward the roller 10, and the roller 10 rotates in a predetermined direction to make the velvet cloth 11 rotate correspondingly. Thus, the velvet cloth 11 directly contacts the second alignment film 140 and steadily rubs the second alignment film 140 from one side of the TFT array substrate 121 to an opposite side thereof. A plurality of grooves (not shown) are formed on the second alignment film 140. At the moment of the roller 10 contacting the second alignment film 140, some scratches may occur on the second alignment film 140. If the scratches occur on the display region 122, an LCD panel is impaired. Thus, as an improvement, in step S13, the second alignment film 140 is not only formed on the display region 122, but also formed on the periphery region 124 so that the roller 10 can be prevented from contacting the display region 122 firstly.

In step S15, a sealant is formed on the sealant adhesive region 125, so as to form a liquid crystal cell.

In step S16, the liquid crystal layer 130 is injected into the liquid crystal cell by a so-called one drop filling (ODF) method.

In step S17, the first mother substrate 110 and the second mother substrate 120 are adhered together to form the mother LCD panel 100.

In step S18, the mother LCD panel 100 is cut up to form a plurality of LCD panels.

However, in step S14, when the roller 10 rotates to the chip attachment region 126 and the sealant adhesive region 125, the velvet cloth may damage the exposed conductive lines on the chip attachment region 126 and the sealant adhesive region 125 because a total area of the two regions 125, 126 is large. Some conductive lines may be cut off, some conductive lines may bend or kink. Therefore, a defective ratio of manufacturing the LCD panel may be increased.

What is needed, therefore, is a method for manufacturing an LCD panel that can overcome the above-described deficiencies.

### SUMMARY

In one preferred embodiment, a manufacturing method for a liquid crystal display (LCD) panel includes: providing a first and a second LCD substrates, each including a display region, a periphery region surrounding the display region, and a sealant adhesive region located between the display region and the periphery region; forming a plurality of data lines and gate lines on the display region, and the data lines and gate lines extending to the periphery region; forming an alignment film on the second LCD substrate, the alignment film covering the display region and the periphery region; rubbing the alignment film; forming a sealant on the sealant region; injecting liquid crystals; attaching the two LCD substrates to form an LCD panel; etching the alignment film to expose end portions of the data lines and gate lines.

Other novel features and advantages of the present methods for manufacturing LCD panels will become more apparent from the following detailed description when taken in conjunction with the accompanying drawings. In the drawings, all the views are schematic.

### BRIEF DESCRIPTION OF THE DRAWINGS

FIG. 1 is a side, cross-sectional view of an LCD panel according to an exemplary embodiment of the present invention, the LCD panel including a color filter substrate and a TFT array substrate.

FIG. 2 is a flowchart summarizing a method for manufacturing the LCD panel according to a first embodiment of the present invention.

FIG. 3 is a bottom plan view of the color filter substrate of FIG. 1, a color filter being forming thereon.

FIG. 4 is a top plan view of the TFT array substrate of FIG. 1, a TFT array layer being formed thereon.

FIG. 5 is a bottom plan view of the color filter substrate of FIG. 1, a first alignment film being formed thereon.

FIG. 6 is a top plan view of the TFT array substrate of FIG. 1, a second alignment film being formed thereon.

FIG. 7 is a top plan view of the LCD panel after the color filter substrate being attached with the TFT array substrate.

FIG. 8 is a top plan view of the LCD panel after part of the alignment film is etched.

FIG. 9 is similar to FIG. 3, but showing a color filter substrate according to a second embodiment of the present invention, a plurality of protrusions being formed on a sealant adhesive region of the color filter substrate.

FIG. 10 is similar to FIG. 4, but showing a TFT array substrate according to a second embodiment of the present invention, a plurality of protrusions being formed on a sealant adhesive region of the TFT array substrate.

FIG. 11 is similar to FIG. 5, but showing the color filter substrate, after an alignment film being formed thereon.

FIG. 12 is similar to FIG. 6, but showing the TFT array substrate, after an alignment film being formed thereon.

FIG. 13 is an exploded, isometric view of a conventional LCD panel, the LCD panel including a first mother substrate and a second mother substrate, the second mother substrate including a plurality of TFT array substrates.

FIG. 14 is a top plan view of one of the TFT array substrates of FIG. 13.

FIG. 15 is a side, plan view of the TFT array substrate of FIG. 14, the TFT array substrate being operated by an alignment apparatus.

### DETAILED DESCRIPTION OF PREFERRED EMBODIMENTS

Reference will now be made to the drawing figures to describe various embodiments of the present invention in detail.

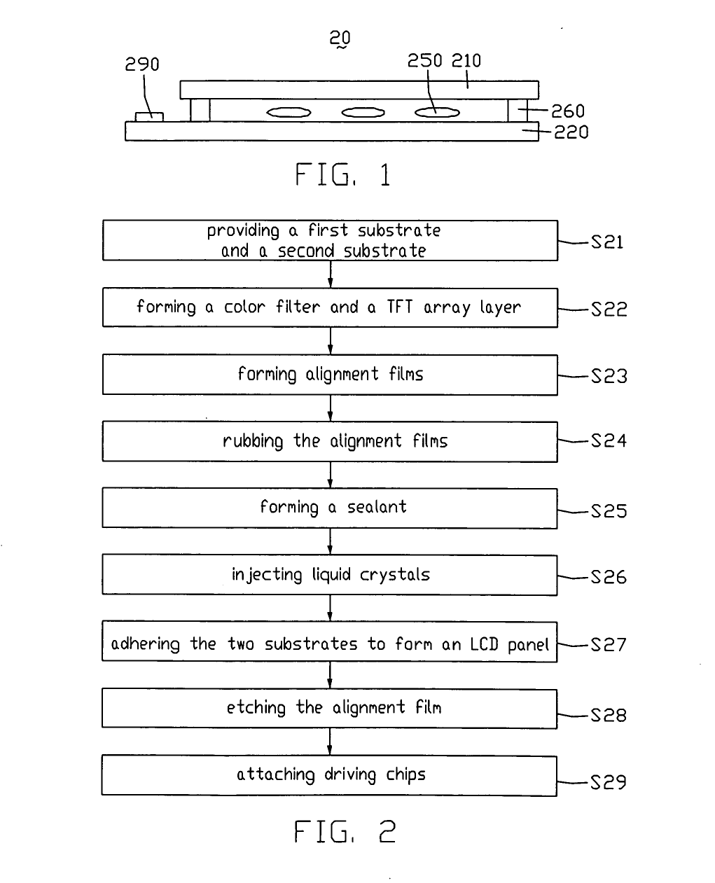

Referring to FIG. 1, an LCD panel according to an exemplary embodiment of the present invention is shown. The LCD panel 20 includes a color filter substrate 210, a TFT array substrate 220 facing the color filter substrate 210, liquid crystals 250 interposed between the two substrates 210, 220, a sealant 260 for adhering the two substrates 210, 220, and driving chips 290. The TFT array substrate 220 is larger than the color filter substrate 210 so as to form an extending region (not labeled) on the TFT array substrate 220. The driving chips 290 are attached on the extending region.

Referring to FIG. 2, this is a flowchart summarizing a method for manufacturing the LCD panel 20 according to a first embodiment of the present invention. The method includes: step S21, providing a first substrate and a second substrate; step S22, forming a color filter and a TFT array layer; step S23, forming alignment films; step S24, rubbing the alignment films; step S25, forming a sealant; step S26, injecting liquid crystals; step S27, adhering the two substrates to form an LCD panel; step S28, etching the alignment film; and step S29, attaching driving chips. The method is described as follows in detail.

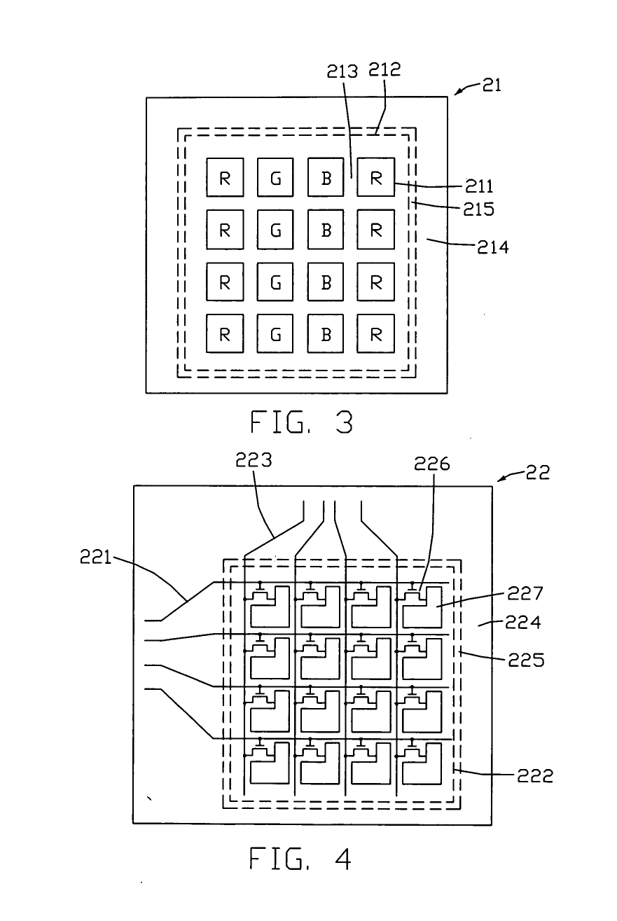

Referring to FIG. 3 and FIG. 4, in step S21, a first substrate 21 and a second substrate 22 are provided. The first substrate 21 includes a first display region 212, a first periphery region 214, and a first sealant adhesive region 215. The first display region 212 is rectangle or square, and locates in a center of the first substrate 21. The first periphery region 214 surrounds the first display region 212. The first sealant adhesive region 215 locates between the first display region 212 and the first periphery region 214. The second substrate 22 includes a second display region 222, a second periphery region 224, and a second sealant adhesive region 225. The second periphery region 224 surrounds the second display region 222, and has a larger area than the first periphery region 214. The second sealant adhesive region 225 locates between the second display region 222 and the second periphery region 224, and corresponds to the first sealant adhesive region 215. The second substrate 22 is larger than the first substrate 21 so as to form an extending region (not labeled) on the second periphery region 224, and the extending region is configured for attaching driving chips.

In step S22, a color filter layer 211 and a black matrix 213 are formed on the first substrate 21, and a TFT array layer (not labeled) is formed on the display region 222 of the second substrate 22. The TFT array layer includes a plurality of gate lines 221, a plurality of data lines 223, a plurality of TFTs 226, and a plurality of pixel electrodes 227. The TFTs 226 locate at intersections formed by the gate lines 221 and the data lines 223. Each of the pixel electrodes 227 is connected to a drain electrode of a corresponding TFT 226. The gate lines 221 and data lines 223 extend to the periphery region 224 and the extending region.

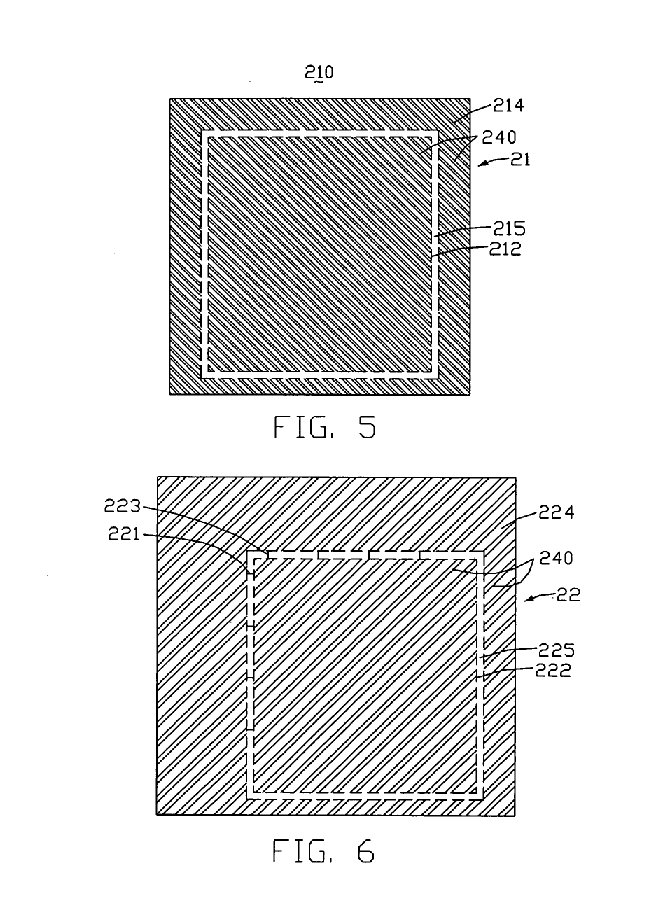

Referring to FIG. 5 and FIG. 6, in step S23, liquid alignment material is coated on the display regions 212, 222 and the periphery regions 214, 224 of the two substrates 21, 22 respectively, by a patterned resin transferring printing board (not shown). The liquid alignment material is hardened to form alignment films 240. The alignment films 240 cover the periphery regions 214, 224 and the display regions 212, 222, and do not cover the sealant adhesive regions 215, 225. Thus, all the gate lines 221 and data lines 223 are covered except those gate lines 221 and data lines 223 located on the second sealant adhesive region 225.

In step S24, a rubbing process of the alignment film 240 is practiced by an alignment apparatus (not labeled). The alignment apparatus (not shown) includes a roller wrapped with a velvet cloth and a workbench for supporting the TFT array substrate 22. The workbench is moved horizontally toward the roller, and the roller rotates in a predetermined direction to make the velvet cloth rotate correspondingly. Thus, the velvet cloth directly contacts the alignment film 240 and steadily rubs the alignment film 240 from one side of the second substrate 22 to an opposite side thereof. A plurality of grooves are formed on the alignment film 240. Thus, a color filter substrate 210 and a TFT array substrate 220 are formed.

In step S25, a sealant is formed on the sealant adhesive region 225, so as to form a liquid crystal cell.

In step S26, liquid crystals 250 are injected into the liquid crystal cell by a so-called one drop filling (ODF) method.

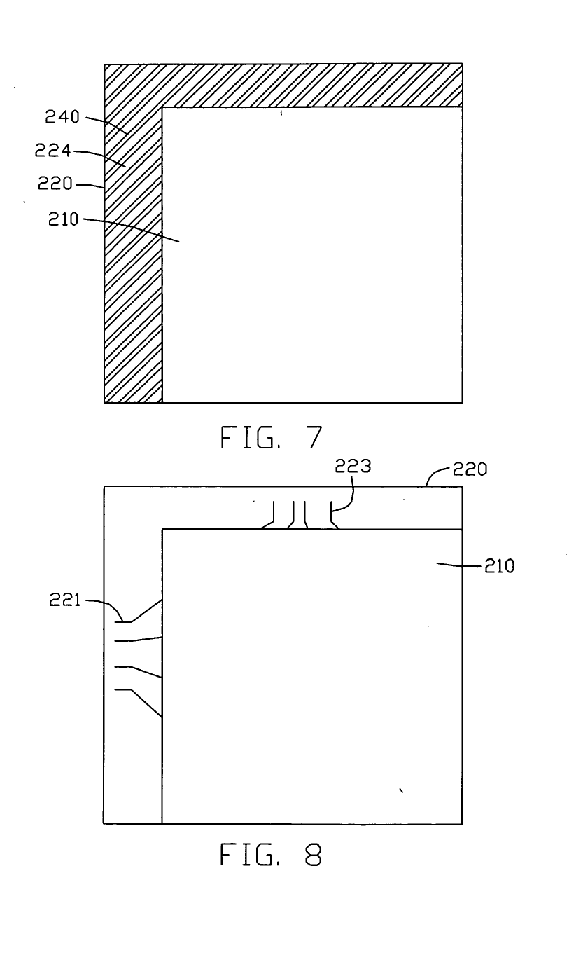

In step S27, referring to FIG. 7, the color filter substrate 210 and the TFT array substrate 220 are adhered together to form an LCD panel.

In step S28, referring to FIG. 8, the alignment film 240 located on the periphery region 224 is etched away by a wet-etching method so as to expose end portions of the gate lines 221 and data lines 223.

In step S29, the driving chips 290 are attached on the TFT array substrate 22. This is a so called chip on glass (COG) using a hot pressing method. The driving chips 290 are connected with the data lines 223 and gate lines 221.

Unlike the conventional manufacturing method, the alignment film 240 is formed on an entire region of the second substrate 22 except the sealant adhesive region 225. The data lines 223 and the gate lines 221 are substantially covered completely, thus, they are not liable to be damaged when the alignment film 240 is rubbing. After forming the LCD panel 20, the alignment film 240 is then etched away to expose the end portions of the data lines 223 and the gate lines 221. In the end, the data lines 223 and the gate lines 221 are connected with the driving chips 290.

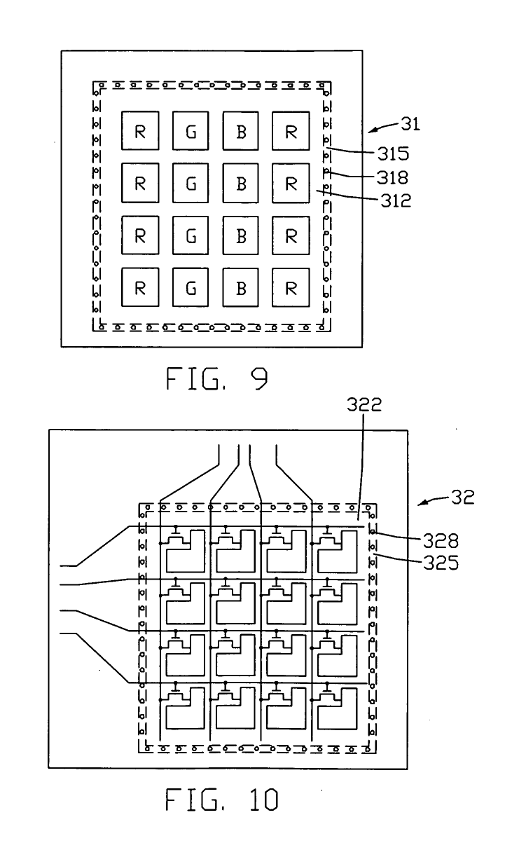

A method for manufacturing an LCD panel according to a second embodiment of the present invention is described as follows. The method is similar to the method according to the first embodiment. However, referring to FIGS. 9 and 10, in step S32, when a color filter 312 is formed on a first substrate 31, and a TFT array layer 322 is formed on a second substrate 32, a plurality of protrusions 318, 328 are formed in sealant adhesive regions 315, 325 respectively. Each of the protrusions 318, 328 has a cylinder-shaped bottom body and a cone-shaped top portion, and has a height of 2˜6 micrometers in total. The cylinder-shaped bottom body has a diameter of 10˜20 micrometers. The protrusions 318 on the first substrate 31 can be made from the same materials as the color filter 312.

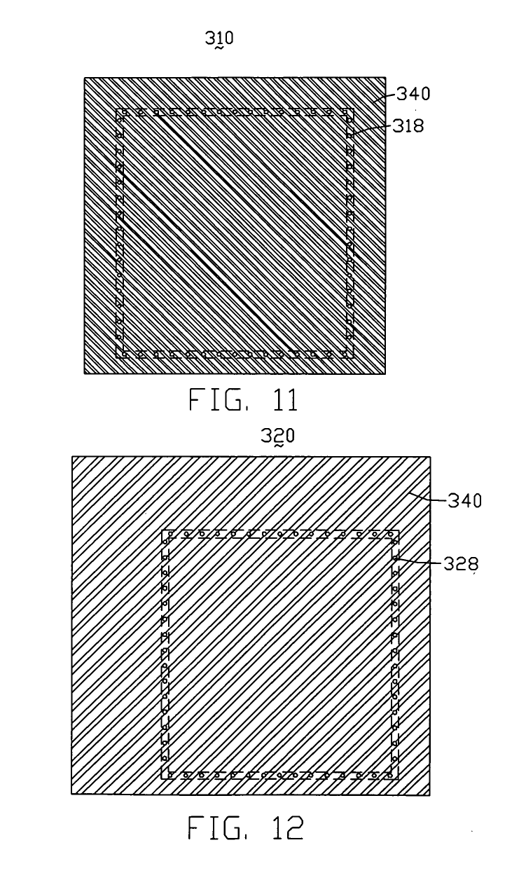

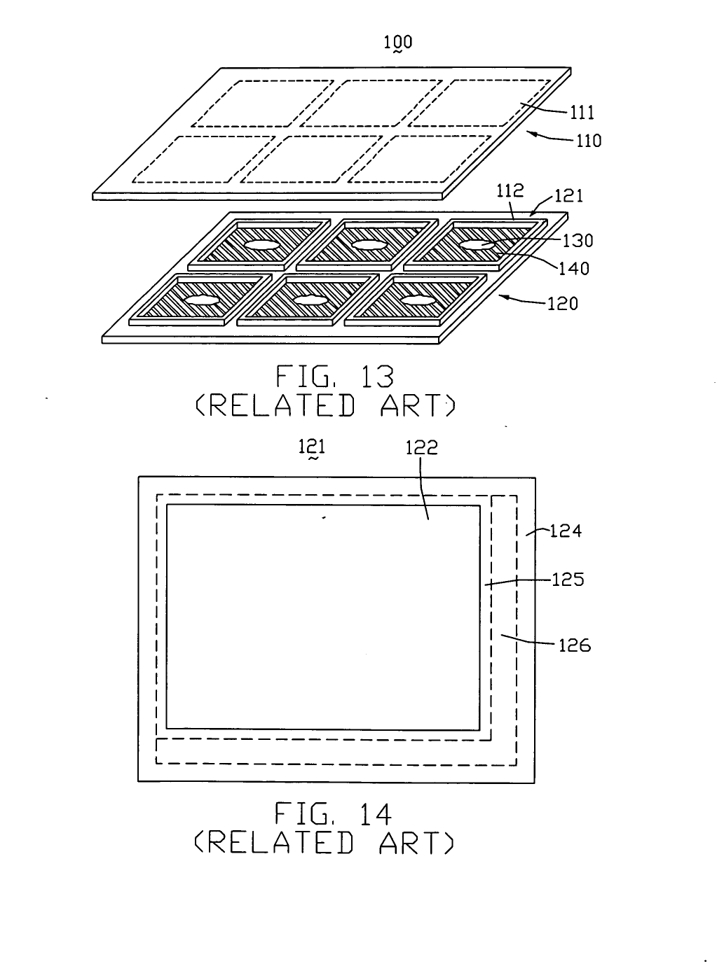

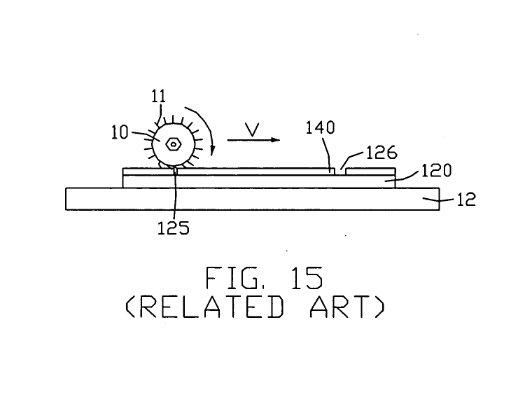

Referring to FIG. 11 and FIG. 12, in step S33, liquid alignment material is coated on entire regions of the two substrates 31, 32 including sealant adhesive regions 315, 325 of the two substrates 31, 32 using a resin transferring printing board (not shown). At this circumstance, the resin transferring printing board needs not to be patterned. The alignment liquids coated on the sealant adhesive regions 315, 325 can flow down to areas between the protrusions 318, 328. The liquid alignment material is hardened to form alignment films 340. Thus, all gate lines and data lines are covered by the alignment film 340.

Compared to the method of the first embodiment, the roller and the velvet cloth can not damage the data lines and gate lines. Thus, the gate lines and the data lines can be protected better because all the gate lines and data lines are covered by the alignment film 340. Furthermore, cost is decreased because the resin transfer printing board needs not to be patterned.

Further and/or alternative embodiments includes the followings. In step S29 of the first embodiment, the etching method can be a dry etching method. In step S32 of the second embodiment, the formed protrusions 318, 328 can be cylinder-shaped or trapezium-shaped.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a liquid crystal display (LCD) panel, the method comprising:
providing a first and a second substrates, each comprising a display region, a periphery region surrounding the display region, and a sealant adhesive region located between the display region and the periphery region;
forming a plurality of data lines and gate lines on the display region, and the data lines and gate lines extending to the periphery region;
forming an alignment film on the second substrate, the alignment film covering the display region and the periphery region;
rubbing the alignment film;
forming a sealant on the sealant region;
injecting liquid crystals;
attaching the two substrates to form an LCD panel; and
etching the alignment film to expose end parts of the data lines and gate lines.

2. The method as claimed in claim 1, wherein a black matrix and a color filter are formed on the first substrate.

3. The method as claimed in claim 2, wherein a plurality of protrusions are formed on the sealant regions of the two substrates.

4. The method as claimed in claim 3, wherein a height of the protrusions is in the range from 2 micrometers to 6 micrometers.

5. The method as claimed in claim 3, wherein the protrusions on the first substrate are made from the same material as the color filter.

6. The method as claimed in claim 3, wherein the protrusions are cylinder-shaped or trapezium-shaped.

7. The method as claimed in claim 3, wherein the protrusions have a cylinder-shaped bottom body and a cone-shaped top portion.

8. The method as claimed in claim 3, wherein the alignment film is formed by hardening liquid alignment material coated on the second substrate.

9. The method as claimed in claim 8, wherein the alignment film covers the display region, the periphery region, and the sealant adhesive region.

10. The method as claimed in claim 1, wherein an etching method is wet etching.

11. The method as claimed in claim 1, wherein an etching method is dry etching.

12. The method as claimed in claim 1, further comprising attaching driving chips on the periphery region, the driving chips connected with the data lines and gate lines.

13. A method for manufacturing a liquid crystal display (LCD) panel, the method comprising:
step S1, providing a first and a second substrates, each comprising a display region, a periphery region surrounding the display region, and a sealant adhesive region located between the display region and the periphery region;
step S2, forming a plurality of data lines and gate lines on the display region, and the data lines and gate lines extending to the periphery region;
step S3, forming a plurality of protrusions on the sealant adhesive region;
step S4, forming an alignment film on the entire regions of the second substrate;
step S4, rubbing the alignment film;
step S5, forming a sealant on the sealant region;
step S6, injecting liquid crystals;
step S7, attaching the two substrates to form an LCD panel; and
step S8, etching the alignment film to expose end portions of the data lines and gate lines.

14. The method as claimed in claim 13, wherein in step S8, the alignment film located on the periphery region is etched away.

15. The method as claimed in claim 13, wherein the protrusions are cylinder-shaped or trapezium-shaped.

16. The method as claimed in claim 13, wherein the protrusions have a cylinder-shaped bottom body and a cone-shaped top portion.

17. The method as claimed in claim 13, wherein the alignment film is formed by hardening alignment liquids coated on the second substrate.

18. The method as claimed in claim 13, further comprising a step S9, in step S9, driving chips are attached on the periphery region, and are connected with the data lines and gate lines.
